(19) United States
(12) Patent Application Publication
(10) Pub. No.: US 2025/0128795 A1
(43) Pub. Date: Apr. 24, 2025

(54) TOWABLE OFFSHORE FLOATING STRUCTURE

(71) Applicant: Korea Institute of Ocean Science & Technology, Busan (KR)

(72) Inventors: Byoung Jae PARK, Daejeon (KR); Kang Su LEE, Daejeon (KR); Byoung Wan KIM, Sejong (KR); Min Suk KI, Sejong (KR)

(73) Assignee: Korea Institute of Ocean Science & Technology, Busan (KR)

(21) Appl. No.: 18/978,792

(22) Filed: Dec. 12, 2024

Related U.S. Application Data
(63) Continuation of application No. PCT/KR2023/020411, filed on Dec. 12, 2023.

(30) Foreign Application Priority Data
Oct. 20, 2023 (KR) 10-2023-0141132

(51) Int. Cl. B63B 35/44

(52) U.S. Cl. CPC B63B 35/44; B63B 2035/446

(57) ABSTRACT

The present invention includes a plurality of legs arranged in a spaced-apart manner; and a connecting bar connected to each pair of legs; further including a cover member arranged to partially wrap around an outer surface of at least one of the legs, wherein when towing is performed at sea, a flow of seawater is guided to an outer side of the leg through contact with the cover member, suppressing the flow of seawater between each pair of legs and thereby reducing resistance caused by the seawater.

### CROSS-REFERENCE TO RELATED APPLICATIONS

This application is a continuation of PCT/KR2023/020411 filed on Dec. 12, 2023, which claims priority to Korean Patent Application No. 10-2023-0141132 filed on Oct. 20, 2023, the entire contents of which are herein incorporated by reference.

### TECHNICAL FIELD

[1] The present invention relates to an offshore floating structure, and more specifically, to a towable offshore floating structure in which a cover member is arranged on the outer side of at least one leg, and the flow of seawater is guided to the outer side of the leg through contact with the cover member, thereby suppressing the flow of seawater between each pair of legs, reducing the resistance caused by the seawater, and facilitating smoother movement on the sea.

### BACKGROUND

As environmental pollution due to the use of fossil fuels becomes increasingly sever, eco-friendly renewable energy is attracting attention.

Eco-friendly renewable energies have the advantage of being clean, not only free from concerns of depletion, but also being pollution-free and regenerative, and its application range is gradually expanding.

Meanwhile, wind energy, which utilizes a wind power generator, is one form of the eco-friendly renewable energies.

In this case, a wind power generator has turbines mounted on a tower that extends vertically, and power can be generated as the turbines rotate due to the wind.

However, since the turbines that make up the wind power generator are quite large, a relatively large installation space is required, which leads to limitations in choosing suitable installation locations.

In addition, when the turbines of the wind power generator rotate, the turbines generate considerable noise, which can become a source of complaints from the surrounding area.

To solve this problem, offshore wind power generators have recently been used.

Offshore wind power generators are installed in the sea away from residential area and the like, which not only makes it easier to secure space but also frees them from complaints related to noise generation.

In this case, fixing the offshore wind power generator directly to the sea will increase the underwater work load increase, and inevitably leads to a higher demand for materials such as piles, resulting in greater cost burdens.

For this reason, the installation of offshore wind power generators on “offshore floating structures,” as disclosed in Korean Patent Application Publication No. 10-2023-0061118, has been increasing recently.

Installing offshore wind power generators using offshore floating structures can reduce the underwater work load and the demand for materials such as piles, thereby lessening the cost burden.

However, general offshore floating structures used in offshore floating wind power systems and the like, had the problem of being difficult to tow.

That is, typical offshore floating structures applied to offshore floating wind power systems and the like have a plurality of legs arranged in a spaced-apart manner. Thus, during the towing process, seawater flow occurs between each pair of legs, which generates considerable resistance. As a result, there are problems such as a decrease in the output and fuel efficiency of the towing vessel during towing at sea, which increases the cost required for towing.

For the reasons mentioned above, efforts are being made in the field to develop an offshore floating structure that can reduce the resistance caused by the seawater and facilitate smooth towing. However, satisfactory results have not yet been achieved to date.

### CITATION LIST

### Patent Literature

PTL 1: Korean Patent Application Publication No. 10-2023-0061118

### SUMMARY OF INVENTION

### Technical Problem

The present invention has been proposed to solve the problems of the above-mentioned prior art, and an object thereof is to provide an offshore floating structure that suppresses the flow of seawater between each pair of legs during towing, reducing the resistance caused by the seawater, thereby facilitating smoother movement on the sea.

### Solution to Problem

In order to achieve the above object, the present invention proposes a towable offshore floating structure including:
a plurality of legs arranged in a spaced-apart manner; and a connecting bar connected to each pair of legs; further comprising a cover member arranged to partially wrap around an outer surface of at least one of the legs, wherein when towing is performed at sea, a flow of seawater is guided to an outer side of the leg through contact with the cover member, suppressing the flow of seawater between each pair of legs and thereby reducing resistance caused by the seawater.

### Advantageous Effects of Invention

The towable offshore floating structure according to the present invention includes the legs and the connecting bars, as well as a cover member arranged to partially cover the outer surface of at least one of the legs. Thus, during the towing process at sea, the flow of seawater is guided to the outer side of the legs through contact with the cover member, suppressing the flow of seawater between each pair of legs, reducing the resistance caused by the seawater, and thereby facilitating the towing at sea.

In addition, in the towable offshore floating structure according to the present invention, the cover member is fixed to the leg by the fastening member. Thus, the cover member can be detached from the leg by releasing the fastening member. Therefore, the detached cover member can be applied to another offshore floating structure, thereby enhancing the usability of the cover member.

### BRIEF DESCRIPTION OF DRAWINGS

FIG. 1 is a perspective view showing the external appearance of a towable offshore floating structure according to the present invention.

FIG. 2 is an exemplary drawing showing towing of a towable offshore floating structure according to the present invention.

FIG. 3 is an exemplary drawing showing the guidance of seawater flow by a cover member when a towable offshore floating structure according to the present invention is towed.

FIG. 4 is an exemplary drawing showing the attachment of a cover member in a towable offshore floating structure according to the present invention.

FIG. 5 is an exemplary drawing showing a form in which a leg includes a protrusion in a towable offshore floating structure according to the present invention.

### DESCRIPTION OF EMBODIMENTS

Hereinafter, the present invention will be described in detail with reference to the accompanying drawings.

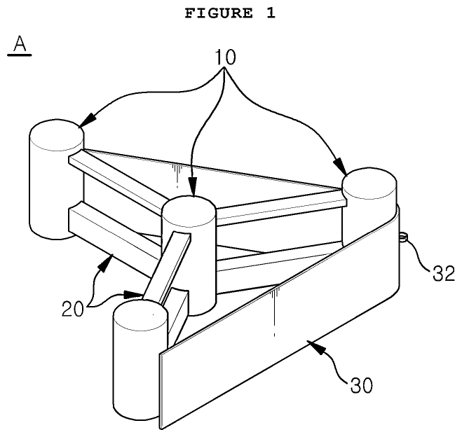

As shown in FIG. 1, a towable offshore floating structure A according to the present invention includes legs 10 and connecting bars 20.

In the present invention, a plurality of legs 10 are provided and arranged in a spaced-apart manner.

Therefore, an object to be supported (not shown in the drawing) placed on the upper part of the legs 10 may be supported by each of the legs 10.

In this case, since the legs 10 have buoyancy, the object supported by the legs 10 may float on the sea.

Here, the number and arrangement of the legs 10 are not limited.

For example, three legs 10 may be arranged in a triangular configuration, or four legs 10 may be arranged in a quadrangular configuration, with an additional leg 10 optionally positioned at the center of the triangular or quadrangular configuration.

Meanwhile, the leg 10 may include a protrusion 11 arranged at least at one location on its outer surface.

Therefore, by attaching the cover member 30 described below to the protrusion 11, the cover member 30 may be spaced apart from the outer surface of the legs 10.

In this case, a bolt fastening hole (not shown in the drawing) is formed in the protrusion 11, so that a fastening member 31 described below, that is, a bolt, can be fastened into the bolt fastening hole. In this way, the cover member 30 can be attached to the protrusion 11.

The connecting bar 20 of the present invention is connected between each pair of legs 10.

Therefore, a plurality of legs 10 may be connected by the connecting bar 20.

In this case, a plurality of connecting bars 20 may be provided between each pair of legs 10.

Therefore, a stable connection between each pair of legs can be achieved using the plurality of connecting bars 20.

Such a connecting bar 20 serves solely to connect each pair of legs and does not perform any special function; therefore, a detailed description of the connecting bar 20 is omitted.

In addition, the towable offshore floating structure A according to the present invention further includes a cover member 30.

The cover member 30 of the present invention is arranged to partially wrap the outer surface of at least one leg 10.

Therefore, when the towable offshore floating structure A is towed in the sea, the seawater can be guided to flow outwardly around the leg 10 through contact with the cover member 30.

In this case, the cover member 30 partially wraps around the outer surface of at least one leg 10, including the section between the leg 10 and another leg 10 spaced therefrom. Thus, the flow of seawater may be guided to the outer side of the leg 10 in the section between the leg 10 and another leg 10 spaced therefrom.

In addition, the cover member 30 is shaped to gradually taper from the rear toward the front. Thus, when the seawater contacts the front of the cover member 30, the flow is dispersed outward and moves toward the rear, thereby reducing the resistance caused by the seawater.

Additionally, the foremost part of the cover member 30 is shaped as a curved surface with a constant curvature, so that when seawater contacts this curved surface, the resistance caused by the seawater is further reduced.

Meanwhile, the cover member 30 is fixed to the leg 10 by the fastening member 31.

Therefore, by releasing the fastening member 31, the cover member 30 can be detached from the leg 10, and the detached cover member 30 can be applied to other offshore floating structures.

In this case, the fastening member 31 may be a bolt, but the bolt is only an example of the fastening member 31, and a shackle or the like may be used as the fastening member 31 in addition to the bolt.

In addition, the cover member 30 may include a shackle 32 arranged at least at one location on its outer surface.

Therefore, by securing a towing rope 110 extending from a towing vessel 100 to the shackle 32, the connection of the towing rope 110 can be easily established.

In addition, the cover member 30 may be made entirely of steel, but is not limited thereto.

That is, the cover member 30 can secure buoyancy smoothly by having the outer frame made of steel and the inner portion of the frame made of plastic.

In addition, the cover member 30 may have an approximately triangular shape, but is not limited thereto.

That is, the cover member 30 may be formed in any conventional shape as long as it can guide the flow of fluid in a specific direction while wrapping at least one leg 10, that is, reduce the occurrence of resistance.

The towing process of the towable offshore floating structure A according to the present invention is described in detail as follows.

The towable offshore floating structure A according to the present invention includes the leg 10 and the connecting bars 20.

Therefore, towing may be performed by securing and pulling the towing rope 110 extending from the towing vessel 100 to at least one of the legs 10 and the connecting bars 20.

However, in the present invention, a plurality of legs 10 are provided and arranged in a spaced-apart manner. Thus, during the towing process, seawater flow occurs between each pair of legs, which generates considerable resistance. As a result, there are problems such as a decrease in the output and fuel efficiency of the towing vessel.

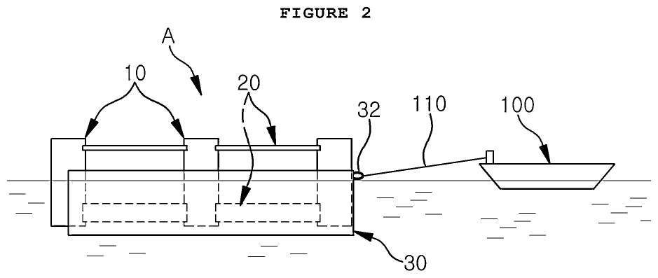

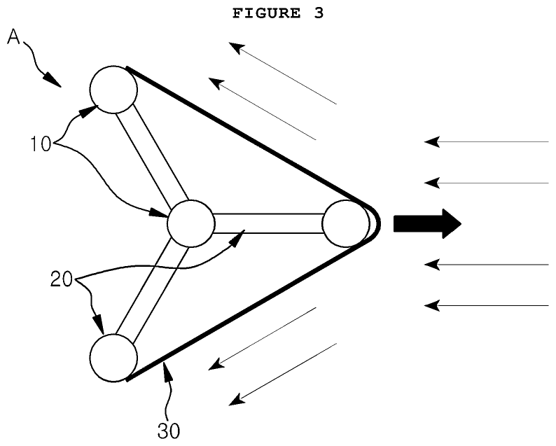

However, the present invention further includes the cover member 30 arranged to partially wrap the outer surface of at least one leg 10. Thus, when towing is performed with the cover member 30 facing the towing vessel 100 as illustrated in FIG. 2, the flow of seawater is guided to the outer side of the legs 10 through contact with the cover member 30 as illustrated in FIG. 3. Therefore, in particular, the flow of seawater between each pair of legs is suppressed, reducing the resistance caused by the seawater and thereby facilitating towing at sea.

In this case, the cover member 30 partially wraps around the outer surface of at least one leg 10, including the section between the leg 10 and another leg 10 spaced therefrom. Thus, the inflow of seawater into the section between the leg 10 and another leg 10 spaced therefrom can be suppressed by the cover member 30. Therefore, the flow of seawater between each pair of legs can be further suppressed, thereby further reducing the resistance caused by the seawater, and thereby facilitating towing at sea.

In addition, the cover member 30 is shaped to gradually taper from the rear to the front. Thus, when the seawater contacts the front of the cover member 30, the flow is dispersed outward and moves toward the rear, thereby reducing the resistance caused by the seawater.

Additionally, the foremost part of the cover member 30 is shaped as a curved surface with a constant curvature. Thus, when seawater contacts this curved surface, the resistance caused by the seawater is further reduced.

Meanwhile, the towable offshore floating structure A according to the present invention allows for the simple connection of the towing rope 110.

That is, the cover member 30 according to the present invention may include the shackle 32 arranged at least at one location on the outer surface. Thus, by securing a towing rope 110 extending from the towing vessel 100 to the shackle 32, the connection of the towing rope 110 can be easily established.

In addition, the towable offshore floating structure A according to the present invention can enhance the usability of the cover member 30.

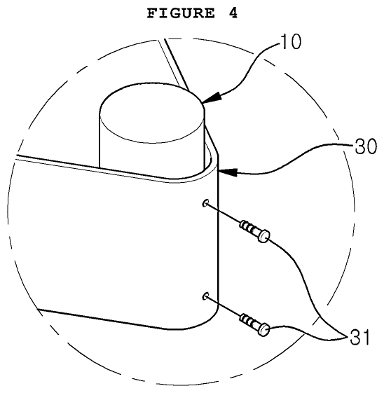

That is, the cover member 30 of the present invention is fixed to the leg 10 by the fastening member 31 as shown in FIG. 4. Thus, the cover member 30 can be detached from the leg 10 by releasing the fastening member 31. Therefore, the detached cover member 30 can be applied to another offshore floating structure, thereby enhancing the usability of the cover member 30.

In addition, the towable offshore floating structure A according to the present invention allows for easy attachment of the cover member 30.

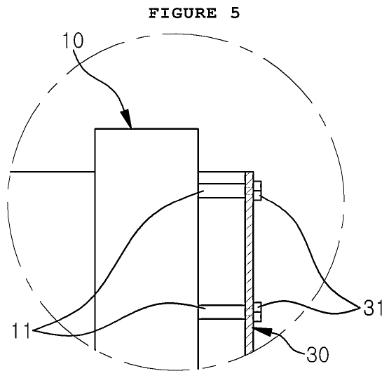

That is, the leg 10 of the present invention may include the protrusion 11 arranged at least at one location of the outer surface as shown in FIG. 5, and a bolt fastening hole may be formed in the protrusion 11. Thus, by fastening the fastening member 31 penetrating the cover member 30, that is, the bolt tip, into the bolt fastening hole formed in the protrusion 11 of the leg 10, the attachment of the cover member 30 can be easily achieved.

The present invention as described above is not limited to the above-described embodiments. Various modifications may be made within a scope that does not depart from the gist of the present invention claimed in the claims, and such modifications are within the protection scope of the present invention defined by the description of the claims below.

### REFERENCE SIGNS LIST

10: Leg
11: Protrusion
20: Connecting bar
30: Cover member
31: Fastening member
32: Shackle
100: Towing vessel
110: Towing rope
A: Offshore floating structure

### INDUSTRIAL APPLICABILITY

The present invention has potential industrial applicability in the production of towable offshore floating structures because a cover member is arranged on the outer side of at least one leg, and the flow of seawater is guided to the outer side of the leg through contact with the cover member, thereby suppressing the flow of seawater between each pair of legs, reducing the resistance caused by the seawater, and facilitating smoother movement on the sea.

1. A towable offshore floating structure comprising:
a plurality of legs arranged in a spaced-apart manner; and
a connecting bar connected to each pair of legs, the towable offshore floating structure further comprising:
a cover member arranged to partially wrap around an outer surface of at least one of the legs, wherein
when towing is performed at sea,
a flow of seawater is guided to an outer side of the leg through contact with the cover member, suppressing the flow of seawater between each pair of legs and thereby reducing resistance caused by the seawater.

2. The towable offshore floating structure of claim 1, wherein
the leg includes a protrusion arranged at least at one location on the outer surface.

3. The towable offshore floating structure of claim 1, wherein
the cover member is fixed to the leg by a fastening member.

4. The towable offshore floating structure of claim 1, wherein
the cover member is shaped to gradually taper from the rear to the front.

5. The towable offshore floating structure of claim 1, wherein
the cover member includes a shackle arranged at least at one location on the outer surface.
